(19) United States
(12) Patent Application Publication
(10) Pub. No.: US 2004/0186998 A1
(43) Pub. Date: Sep. 23, 2004

(54) Integrated security information management system and method

(76) Inventors: Ju-Han Kim, Daejon (KR); Ki-Young Moon, Daejon (KR); Sung-Won Sohn, Daejon (KR); Chee-Hang Park, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/749,649

(22) Filed: Dec. 30, 2003

(30) Foreign Application Priority Data
Mar. 12, 2003 (KR) 2003-87371

(51) Int. Cl. H04L 9/00

(52) U.S. Cl. 713/169

(57) ABSTRACT

Disclosed is an integrated security information management system and method. The system includes: an XML key managing unit for performing an interface based on an XML, authenticating a user, analyzing a request, and requesting an access control unit, an authenticating unit or an external public key infrastructure certification server; the access control unit for providing a user authenticating function, an access authority policy generating function, an access authority confirming function, a shared security information providing function, a security information position information providing function, a shared security information registering/deleting/updating function, a shared security information share setting/releasing function, and an XML digital signature/verification/encryption/decryption/communication security function; the authenticating unit for providing the user authenticating function, a person-in-question authenticating function, a non-shared security information providing function, a security information position providing function, a non-shared security information registering/modifying/deleting function, and the XML digital signature/verification/encryption/decryption/communication security function; the limited shared data storing unit for storing and managing security information; and a non-shared data storing unit for storing and managing security information.

### FIELD OF THE INVENTION

The present invention relates to an integrated security information management system and method; and, more particularly, to an integrated security information management system and method in which compatibility and mobility of the security information are increased by integrally managing a variety of security information according to an extensible markup language (XML) based international standard.

### DESCRIPTION OF THE PRIOR ART

At present, due to a development of an information communication technology, services using an open communication network (i.e., Internet), such as an electronic commerce (EC), an electronic document transaction, a communication and the like, are rapidly widely used in various fields throughout the world. Here, the electronic commerce can be defined including all economic activities, such as advertisement, marketing, and exchange of product and service and even up to exchange of their related information, which are done by an enterprise or a consumer utilizing an information communication network.

However, since all information and data are exchanged using an electronic method in the electronic commerce and the electronic document transaction utilizing the Internet, there may occur problems of security or certification that has been not required in a conventional information exchanging method using a paper document or in a conventional information exchanging method using a closed electronic document exchange. In other words, there occur problems of an identification between information exchanging parties, an integrity related with whether or not the exchanged information is altered, a non-repudiation of transaction between parties, an evidence guarantee for the exchanged information, and the like.

In order to prevent disputes caused by the above problems, a certification authority utilizing and managing a security technology intervenes in all steps of the electronic commerce and the electronic document transaction. A public key infrastructure (PKI), a digital signature, biometrics and the like are proposed as typical security technologies.

First, the public key infrastructure (PKI) can be considered as a certification mechanism having a plurality of certification authorities connected hierarchically. The plurality of certification authorities enable the security service using a public key encryption manner to be effectively used in an environment of an open information communication network such as Internet or a distributed information communication network environment. Here, the public key encryption manner is required for the integrity that confirms whether or not information transacted between users is altered, an authentication for the user identification, an after non-repudiation of self-action, and the like. That is, the public key infrastructure can be considered as a collection of hardware, software and policies for managing various keys, such as a private key, a public key, and the like, which are required for a generation, process and revocation procedure of a certificate for providing the security services of the integrity, the certification and the non-repudiation and required for digital signature generation and confirmation.

An information security divisional committee and a ministry of information and communication take charge of a basic policy decision for construction and management of a domestic public key infrastructure (PKI), and Korea information security center takes charge of a certificate issuance and a public certification management for the certification authority being a root certification authority (CA). The certification authority (CA) performs a certification business of the certificate issuance for subscribers and, if necessary, it allows a registration authority (RA) to perform an agency business for subscriber identification and registration. A public key based security service following an Internet banking is rapidly currently supplied together with proclamation of a digital signature law on October 2000.

However, the public key infrastructure (PKI) technology does not manage up to a different kind of security information, and several certificates and private key should be individually managed using other management instruments.

As another security technology is a digital signature technology, in which the electronic document is signed so as to claim and recognize a person's peculiarity such as a conventional legal seal or signature.

The digital signature technology has unforgeable, signor authentication, non-repudiation, unalterable and non-reusable characteristics and can be classified into a direct signing manner using the public key infrastructure and a mediator signing manner generating and verifying the signature through a trusted third party (TTP). Specifically, since the users should own a common private key in the direct signing manner using the public key infrastructure, a complicated procedure of a key distribution is required. Since general users cannot solve a complicated key distribution problem, a public-trusted certification authority provides various services for managing the key and securing an identity.

However, since the security technologies using the public key infrastructure manner have not yet a regulated standard, it is of frequent occurrence that several certificates should be owned since key managing methods are different from each other and are not compatible with each other. Further, since management instrument requiring formats are all different even when the security information is of the same kind, the security information should be reset in conformity to each management instrument and also has a limit in use. In order to solve the above problems, an XML key management specification (XKMS) has been developed.

The XML key management specification (XKMS) defines a protocol for managing the public key for verifying or encrypting the signature of the electronic document in various and complicated functional electronic transaction applications so that the conventional public key infrastructure (PKI) and public key certificate, and an XML application can be easily integrated.

The XML key management specification includes two regions, that is, an XML Key Information Service Specification (X-KISS) and an XML Key Registration Service Specification (X-KRSS). The XML Key Information Service Specification (X-KISS) is a protocol for supporting public key position and identifier information and a public key connection function. The XML Key Registration Service Specification (X-KRSS) is a protocol for supporting a key-pair owner's registration of a key pair. Each of the services includes a simple request and response.

In the meanwhile, the XML Key Management Specification (XKMS) can solve the compatibility problem of the security information used in between the management instruments by managing the security information used in the public key infrastructure according to the XML based international standard, but has a problem that other security information (for example, password (passphrase) information, a Web-Service security token, and bio information used widely and most simply in an Internet service) cannot be integrally managed depending on a security level.

### SUMMARY OF THE INVENTION

It is, therefore, an object of the present invention to provide an integrated security information management system and method in which compatibility and mobility of the security information are increased by integrally managing a variety of security information according to an extensible markup language (XML) based international standard.

In-accordance with one aspect of the present invention, there is provided an integrated security information management system, including: an Extensible Markup Language (XML) key managing unit for performing an interface with an external security information management client based on an XML, authenticating a user, analyzing a request from the integrated security information management client, and then requesting an access control unit, an authenticating unit or an external public key infrastructure certification server for process depending on a request kind; the access control unit for providing a user authenticating function, an access authority policy generating function for a limited shared data storing unit, an access authority confirming function depending on the access authority policy, a shared security information providing function for an access-allowed user, a security information position information providing function, a shared security information registering/deleting/updating function, a shared security information share setting/releasing function, and an XML digital signature/verification/encryption/decryption/communication security function depending on a shared security information processing request from the XML key managing unit; the authenticating unit for providing the user authenticating function, a person-in-question authenticating function, a non-shared security information providing function for the access-allowed user (the person-in-question), a security information position providing function, a non-shared security information registering/modifying/deleting function, and the XML digital signature/verification/encryption/decryption/communication security function depending on a non-shared security information processing request from the XML key managing unit; the limited shared data storing unit for storing and managing security information shared by an object limited depending on a control of the access control unit; and a non-shared data storing unit for storing and managing security information that should not be shared depending on a control of the authenticating unit.

In accordance with another aspect of the present invention, there is provided an integrated security information management method, the method including the steps of: classifying security information depending on its kind according to a security information registering/updating/deleting request from an integrated security information management client to register/update/delete the classified security information from a limited shared data storage or a non-shared data storage at an integrated security information management system; setting/releasing a share for the security information registered into the limited shared data storage according to a security information share setting/releasing request from the integrated security information management client, and generating/updating a security access authority policy at the integrated security information management system; confirming a request user's authority depending on a security access authority policy according to a shared security information providing request from the integrated security information management client, and then providing corresponding security information for the integrated security information management client at the integrated security information management system; authenticating that a request user is a non-shared security information owner according to a non-shared security information providing request from the integrated security information management client, and then providing corresponding security information for the integrated security information management client at the integrated security information management system; and generating/verifying a digital signature according to a digital signature generating/verifying request using an XML from the integrated security information management client at the integrated security information management system.

### BRIEF DESCRIPTION OF THE DRAWINGS

The above and other objects and features of the present invention will become apparent from the following description of the preferred embodiments given in conjunction with the accompanying drawings, in which:

FIG. 1 is a construction diagram of an integrated security information management system in accordance with a preferred embodiment of the present invention;

FIG. 2 is a structural diagram of a limited shared data storage in accordance with a preferred embodiment of the present invention;

FIG. 3 is a structural diagram of a non-shared data storage in accordance with a preferred embodiment of the present invention;

FIG. 4 is a flowchart illustrating a security information registering procedure depending on to a request from an extensible XKMS client in an integrated security information management system in accordance with a preferred embodiment of the present invention;

FIG. 5 is a flowchart illustrating a security information share setting/releasing procedure depending on a request from an extensible XKMS client in an integrated security information management system in accordance with a preferred embodiment of the present invention;

FIG. 6 is a flowchart illustrating a security information sharing procedure depending on a request from an extensible XKMS client in an integrated security information management system in accordance with a preferred embodiment of the present invention; and

FIG. 7 is a flowchart illustrating a security information updating procedure depending on a request from an extensible XKMS client in an integrated security information management system in accordance with a preferred embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

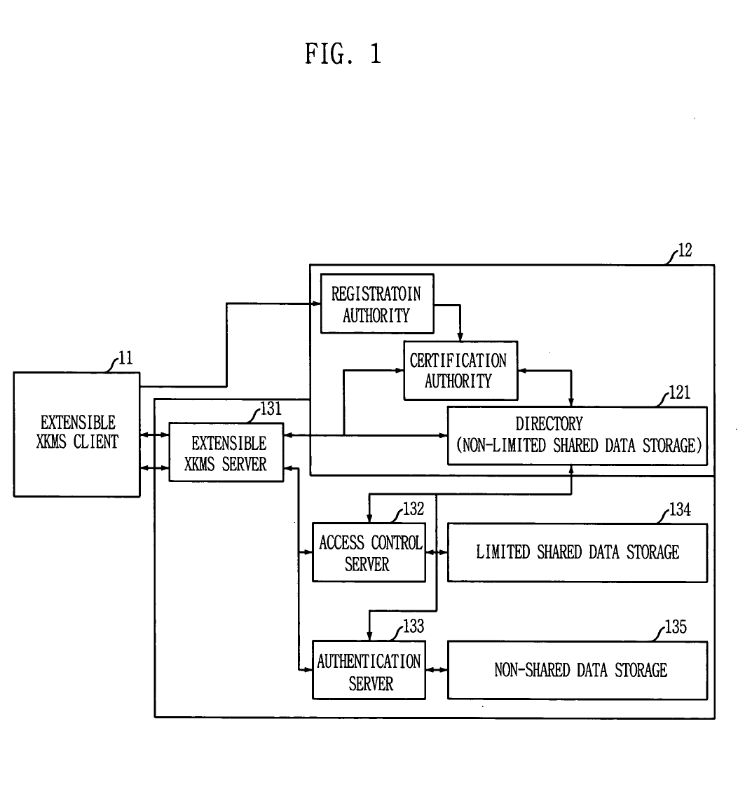

FIG. 1 is a construction diagram of an integrated security information management system in accordance with a preferred embodiment of the present invention.

First, the integrated security information management system 13 in accordance with the present invention is provided for solving a problem of conventional security information managing instruments. The integrated security information management system 13 integrally manages various security information based on a public key infrastructure (PKI) and an XML Key Management Specification (XKMS) and converts on-line and off-line security information according to an XML international standard and then manages the converted information.

Meanwhile, an extensible XKMS client 11 is an extensive version of a function of a conventional XKMS client and can manage the security information of a private key, an attribute certificate, a password, a passphrase, a Web-Service security token and the like, in addition to a management function for a conventional certificate and private key. The extended functions are as follows.

1) Security information position information providing function: a function of providing a position in which the security information is stored.

2) Security information registering function: a function of storing the security information in storage.

3) Security information sharing set/release requesting function: a function of requesting a sharing set/release for the security information stored in a limited shared data storage 134.

4) Security information share agency setting function: a function of receiving a owner's signature for the security information stored in the limited shared data storage 134 such that other users can set/release a sharing.

5) Security information share agency setup confirming function: a function of informing a security information owner of a security information share agency setting request from other users.

6) Security information modifying function: a function of modifying the security information stored in the limited shared data storage 134 and a non-shared data storage 135.

7) Shared security information requesting function: a function of requesting an access to the security information shared by other owners.

8) Security information verification requesting function: a function of requesting an extensible XKMS server 131 for verification on other owners' security information encrypted in a specific format. Herein, when the extensible XKMS server 131 is requested for the security information verification, other owners' security information verification request confirming procedure should be performed.

9) Security information verification request confirming function: a function of informing that a request for verification on self-owning security information is generated from other owners.

10) Security information storing function: a function of storing the security information stored in the limited shared data storage 134 or the non-shared data storage 135 in the same format.

11) Security information generating function: a function of generating a variety of security information and a function of requesting the extensible XKMS server 131 for a security information generation.

12) Security information converting function: a function of converting various formatted security information into an XML format, and converting an XML formatted security information into a specific format.

13) Shared security information usage log confirming function: a function of confirming a log for a shared security information usage stored in the limited shared data storage 134.

14) Shared security information retrieving function: a function of using the signature and the certificate issued from other users to retrieve the security information shared to oneself.

15) Shared security information retrieval confirming function: a function of informing corresponding other users of execution of the shared security information retrieving function depending on the execution.

16) XML digital signature/verification/encryption/decryption/communication security function: a digital signature/verification function, an encryption/decryption function, and a communication security function using the XML.

The above-described functions of the extensible XKMS client 11 are executed by the request to the XKMS server 131, and an actual process according to the request is performed in an access control server 132 or an authentication server 133.

On the other hand, the inventive integrated security information management system 13 includes the extensible XKMS server 131, the access control server 132, the authentication server 133, the limited shared data storage 134, and the non-shared data storage 135.

In the extensible XKMS server 131, a process related to the certificate and the private key is performed between the extensible XKMS client 11 and a PKI certification server 12 in the conventional manner, and other security information (password (passphrase), Web-Service security token, bio information and the like) are processed depending on their kinds in the access control server 132 or the authentication server 133 and stored in the limited shared data storage 134 or the non-shared data storage 135.

That is, the extensible XKMS server 131 is an extensive version of an XML Key Management Specification (XKMS) designed to provide easier user interface between the extensible XKMS client 11 and the PKI certification server 12. A user interfaces with the XML through the extensible XKMS client 11, and the extensible XKMS server 131 mutually converts an XML interface and a PKI interface such that the extensible XKMS client 11 and the PKI certification server 12 are interfaced to each other. At this time, the extensible XKMS server 131 extends and uses the conventional XML Key Management Specification (XKMS) so as to manage the security information of the private key, the attribute certificate, the password (passphrase), the Web-Service security token and the bio information well as the certificate and the private key of the public key infrastructure (PKI). The detailed extending functions are as follows.

1) Client request classifying function: a function of analyzing the request from the extensible XKMS client 11 to send the analyzed request to the PKI certification server 12, the access control server 132 or the authentication server 133.

2) Security information generating function: a function of generating the security information according to the request from the extensible XKMS client 11.

3) Security information converting function: a function of converting the various formatted security information received from the extensible XKMS client 11 into the XML format, and converting the XML formatted security information into a specific format.

4) XML digital signature/verification/encryption/decryption/communication security function: the digital signature/verification function, the encryption/decryption function, and the communication security function using the XML.

The extensible XKMS server 131 having the above-described function converts the request from the extensible XKMS client 11 into the PKI protocol, sends the converted request to the PKI certification server 12, and sends the converted request to the access control server 132 or the authentication server 133.

Further, if necessary, the extensible XKMS server 131 can add management of new security information. In other words, a function can be added for managing the new security information according to enactment of a new XML security standard or according to management necessity of new XML security information. At this time, the added security information is of the XML format and is stored depending on its kind in the limited shared data storage 134 or the non-shared data storage 135. In view of the user, the addition of the new XML security information does not influence the existing interface. That is because the new security information can be added just only by extending a function of the extensible XKMS server 131 since the extensible XKMS server 131 classifies the security information received from the extensible XKMS client 11 depending on its type to request the access control server 132 or the authentication server 133 for process.

Meanwhile, the limited shared data storage 134 stores the security information published only to a limited object such as the private key, the password, the passphrase, and the Web-Service security token that is necessary to be published, and also stores the certificate and the attribute certificate.

Further, the non-shared data storage 135 stores non-sharable security information, such as the private key, the bio information and the Web-Service security token that should not be published.

At this time, the security information stored in the limited shared data storage 134 and the non-shared data storage 135 is XML-encrypted and then stored. In some cases, the security information can be simply expressed in the XML and stored without encryption. The XML encryption is performed in the extensible XKMS client 11 or in the extensible XKMS server 131 according to the request from the extensible XKMS client 11. The XML decryption can be also performed in the extensible XKMS client 11 or in the extensible XKMS server 131. Further, the security information stored in the limited shared data storage 134 and the non-shared data storage 135 can be provided according to the request from the user (extensible XKMS client).

In the meanwhile, the access control server 132 sets an access authority to the limited shared data storage 134 and has the following functions.

1) User authenticating function.

2) Access authority policy generating function to the limited shared data storage 134.

3) Access authority confirming function according to an access authority policy.

4) Shared security information providing function to an access-allowed user.

5) Security information position information providing function.

6) Shared security information registering/modifying/deleting function.

7) Shared security information share setting/releasing function.

8) Security information share agency setting/confirming function.

9) Security information verifying function.

10) Security information verification request confirming function.

11) Security information storing/generating/converting function.

12) Shared security information usage log confirming function.

13) Shared security information retrieving function.

14) Shared security information retrieval request confirming function.

15) XML digital signature/verification/encryption/decryption/communication security function.

As described above, the access control server 132 takes charge of regulating the access to the limited shared data storage 134 and takes charge of the user authentication and the security information authorization. At this time, the user authentication uses the public key infrastructure (PKI), and the authorization for the security information is determined depending on the access authority policy. That is, if the access control server 132 receives the request of the access to the limited shared data storage 134 from the extensible XKMS client 11, the user authentication is first performed and the access authority policy corresponding to the corresponding security information is then read out to confirm whether or not the user has authority. Additionally, only in case the user has the authority, the security information stored in the limited shared data storage 134 is provided.

At this time, the access authority policy is generated when the security information is stored in the limited shared data storage 134 through the extensible XKMS client 11 or when a share is requested to allow an access of a specific user, and managed continuously and dynamically. That is, the access control server 132 updates and stores the access authority policy according to the security information registering/modifying/deleting/share setting and releasing request and the like received through the extensible XKMS client 11. Accordingly, the access authority policy in the access control server 132 is not made by a separate manager as in a general access control system, but it is generated according to the request from the user under a predetermined rule by the access control server 132.

Further, the access control server 132 stores the security information, which does not matter even when it is published to anyone, such as the conventional certificate, attribute certificate and the like in the non-limited shared data storage 121. At this time, the non-limited shared data storage 121 can be included in a directory of the PKI certification server 12. Of course, the conventional directory of the PKI certification server 12 should be extended such that other kinds of security information can be stored since the security information that can be stored is limited to the certificate.

Meanwhile, the authentication server 133 takes charge of regulating the access to the non-shared data storage 135 and performs the following functions.

1) User authenticating function.

2) Person-in-question authenticating function.

3) Access authority result making function.

4) Security information providing function for the access-allowed user.

5) Security information registering/modifying/deleting function.

6) Security information verifying function.

7) Security information verification request confirming function.

8) Security information position providing function.

9) Security information storing function.

10) Security information retrieving function.

11) XML digital signature/verification/encryption/decryption/communication security function.

As described above, the authentication server 133 for regulating the access to the non-shared data storage 135 takes charge of the authentication for the user who intends to access it. Particularly, the non-shared data storage 135 stores important security information that should not be shared, and since publication should be made only to the owner himself, the authentication server 133 should authenticate whether or not the access requesting user is the owner himself. That is, the user authenticating function in the authentication server 133 is a function of authenticating the user, and the person-in-question authenticating function is a function of confirming whether or not the security information to which intends to be accessed is one owned by the user himself.

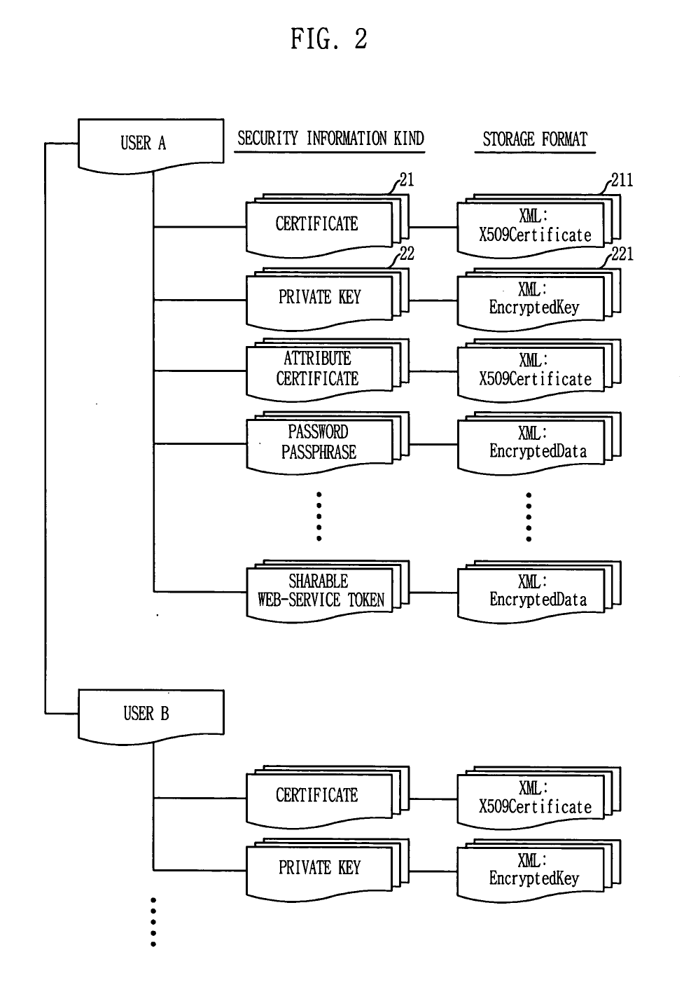

FIG. 2 is a structural diagram of the limited shared data storage in accordance with a preferred embodiment of the present invention.

As shown in FIG. 2, the limited shared data storage 134 in accordance with the present invention includes the security information and the security information format, which are classified according to user and type. In other words, the security information of the certificate, the private key, the attribute certificate, the password, the passphrase, the sharable Web-Service security token and the like is stored according to user and type. Additionally, the security information format is stored corresponding to each security information. The security information format is an information related to the format of the security information substantially stored in the limited shared data storage 134. Among them, some are stored in the encryption format as shown in FIG. 2 or some are stored as the non-encryption formatted security information itself.

For example, the certificate 21 is stored in an “X509Certificate” format 211 and the private key 22 is encrypted and stored in a “EncryptedKey” format 221. However, the stored security information is based on the XML format and conforms to the international XML standard enacted in “W3C (World Wide Web consortium)” or “OASIS”.

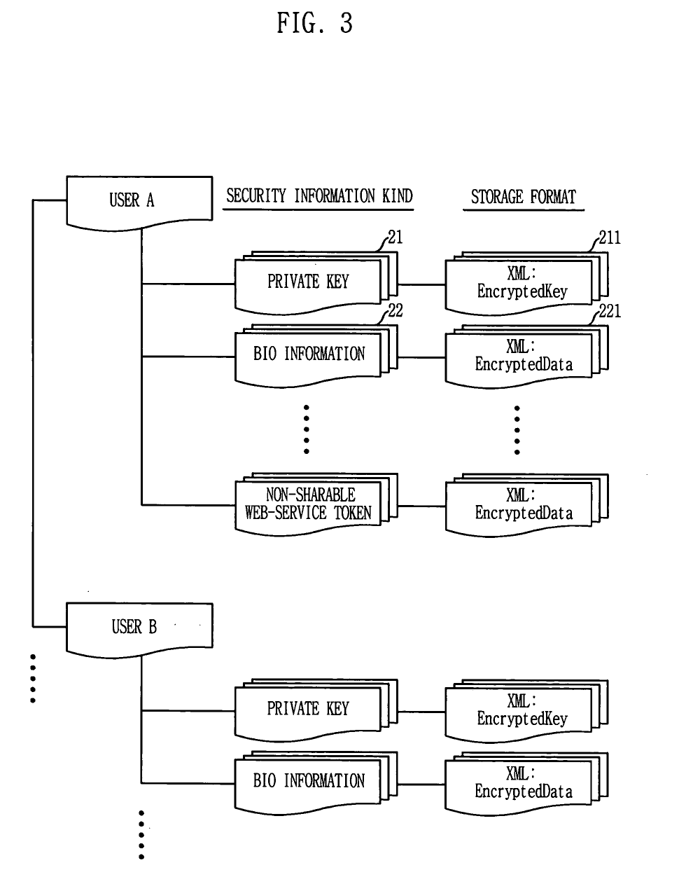

FIG. 3 is a structural diagram of the non-shared data storage in accordance with a preferred embodiment of the present invention.

As shown in FIG. 3, the non-shared data storage 135 in accordance with the present invention includes the security information and the security information format, which are classified according to user and type, like the same manner as the limited shared data storage 134. In other words, the private key, the bio information not being sharable by every user, the non-sharable Web-Service security token and the like are stored. Their storage formats are the XML format, such as “EncryptedKey” or “EncryptedData”. For reference, all of “EncryptedKey” and “EncryptedData” represent that they are encrypted as one element of the XML encryption defined in “W3C”. In case that an encrypted content is a key, the “EncryptedKey” element is used, and in case the encrypted content is data, the “EncryptedData” element is used.

On the other hand, an entire operation procedure of the integrated security information management system in accordance with the present invention will be described below.

First, the user stores a pair of a public key pair in the directory at the PKI certification server 12 through a registration process, like the conventional manner. Then, the user can update or cancel a self-public key pair through the extensible XKMS server 131.

In the meanwhile, the user can request a security information registering/updating/sharing service and the like through the extensible XKMS server 131, and the extensible XKMS server 131 performs the user authentication according to the request from the user and then requests the PKI certification server 12, the access control server 132 or the authentication server 133 for the corresponding service depending on the kind of service-requested security information.

At this time, the access control server 132 requested for the security information sharing service reads the certificate of the request user from the PKI certification server 12 to confirm validity again. After it is confirmed that the user is valid, if the corresponding shared security information is read out from the limited shared data storage 134 and then sent to the extensible XKMS server 131, the extensible XKMS server 131 sends the read security information to the request user through the extensible XMKS client 11.

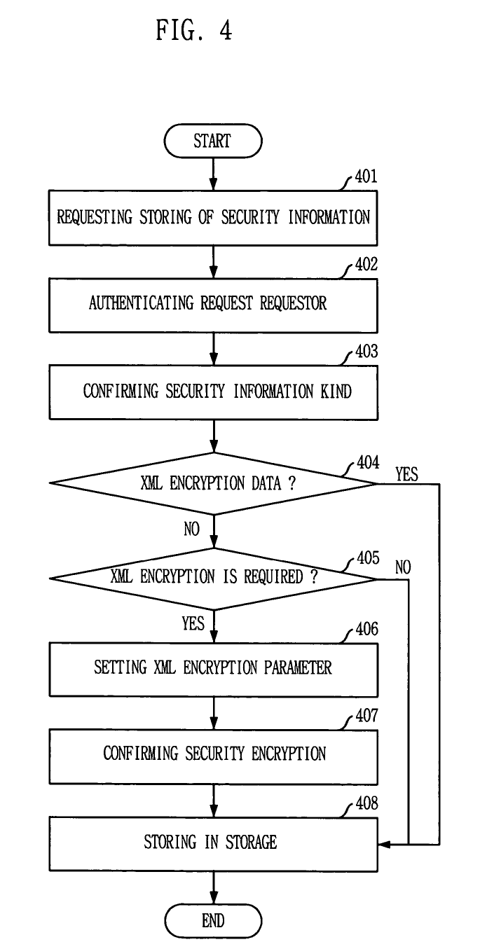

A more detailed procedure will be described with reference to FIGS. 4 to 7.

FIG. 4 is a flowchart illustrating a security information registering procedure depending on the request from the extensible XKMS client 11 in the integrated security information management system in accordance with a preferred embodiment of the present invention.

First, at step 401, if the user requests a storing of the security information through the extensible XKMS client, at step 402, the extensible XKMS server 131 authenticates the request user and, at steps 403 and 404, confirms the kind of the security information.

As the confirmation results, at step 408, if the kind of the security information is XML encryption data, the security information is sent to the access control server 132 or the authentication server 133 to be stored in the limited shared data storage 134 or the non-shared data storage 135.

In the meanwhile, as the confirmation results at the steps 403 and 404, if the kind of the security information is not the XML encryption data, at step 405, it is determined whether or not the XML encryption is required. If the XML encryption is required, at step 406, an XML encryption parameter is set to encrypt the security information at step 407 and then the encrypted security information is sent to the access control server 132 or the authentication server 133 to be stored in the limited shared data storage 134 or the non-shared data storage 135 at step 408. If the XML encryption is not required, the security information is sent to the access control server 132 or the authentication server 133 to be stored in the limited shared data storage 134 or the non-shared data storage 135 at the step 408. At this time, whether or not the XML encryption is required is selectively determined when the user requests storing of the security information.

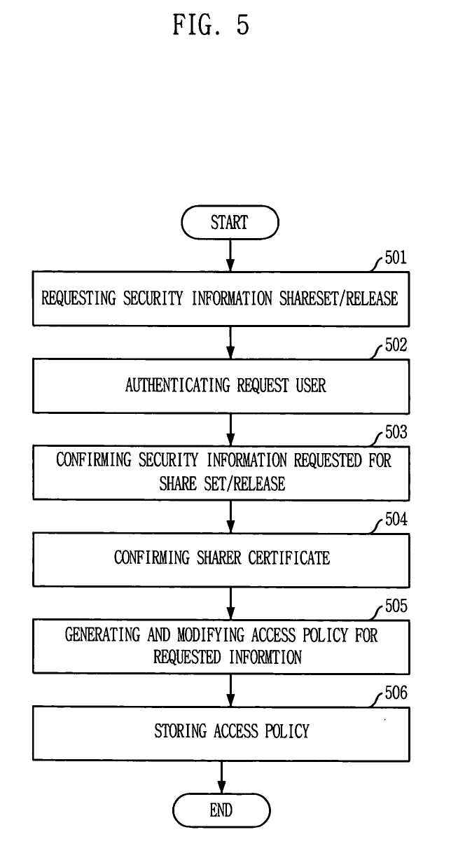

FIG. 5 is a flowchart illustrating a security information share setting/releasing procedure depending on the request from the extensible XKMS client in the integrated security information management system in accordance with a preferred embodiment of the present invention.

Firstly, at step 501, if the user requests the share setting/releasing of self-owning security information through the extensible XKMS client 11, at step 502, the extensible XKMS server 131 authenticates the request user. At step 503, after the share set/release requested security information is confirmed, at step 504, a sharer certificate is confirmed.

Then, at step 505, the access authority policy for the share set/release security information is generated or updated and then stored at step 506. At this time, the generated or updated access authority policy is stored in the access control server 132 for regulating the access to the limited shared data storage 134, and only sharer set to the access authority policy has the authority for allowing the access to the corresponding security information.

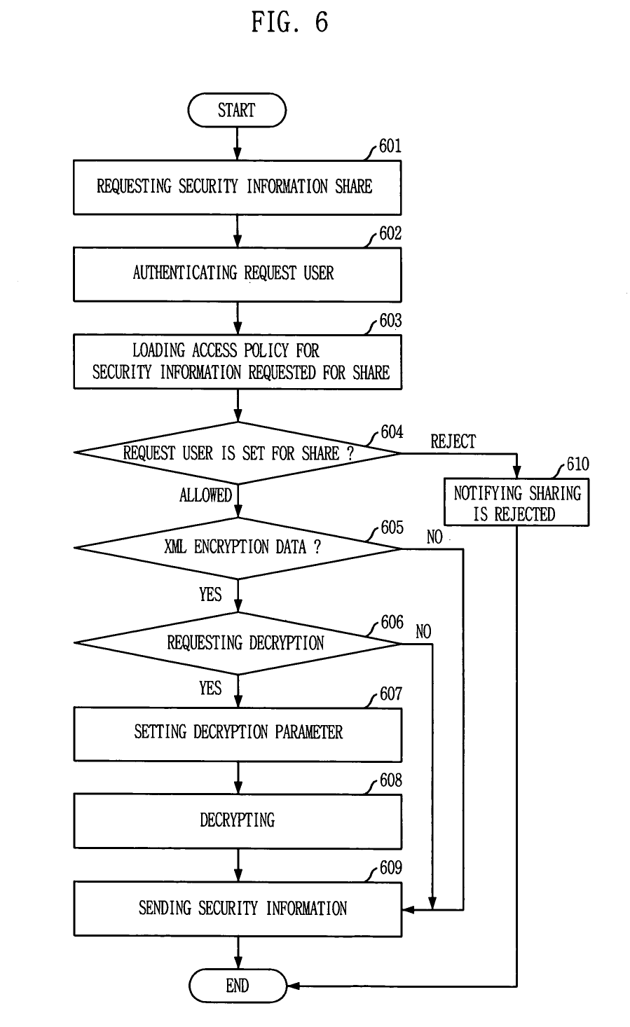

FIG. 6 is a flowchart illustrating a security information sharing procedure depending on the request from the extensible XKMS client in the integrated security information management system in accordance with a preferred embodiment of the present invention.

Firstly, at step 601, if the user requests the security information share through the extensible XKMS client 11, at step 602, the extensible XKMS server 131 authenticates the request user. At step 603, after the access control server 132 loads the access authority policy for the share-requested security information, at step 604, it is confirmed whether or not the access authority policy is set to allow the request user to share it.

As the confirmation result at the step 604, if it is set to allow the share, at step 605, it is confirmed whether or not the security information is XML encryption data. If the security information is not the XML encryption data, a step 609 is performed to send the security information to the request user through the extensible XKMS client 11. If the security information is the XML encryption data, at step 606, it is confirmed whether or not there is a decryption request. If there is the decryption request, at step 607, a decryption parameter is set for decryption at step 608 and then the security information is sent to the request user through the extensible XKMS client 11 at the step 609. Additionally, if there is not the decryption request, the step 609 is performed to send the security information to the request user through the extensible XKMS client 11 at the step 609.

In the meantime, as the confirmation result at step 604, if it is not set to allow the share, the request user is informed that the share is rejected through the extensible XKMS client 11 at step 610.

In the meanwhile, the user can selectively request the XML encrypted data itself or the decrypted data when the security information is requested for the share.

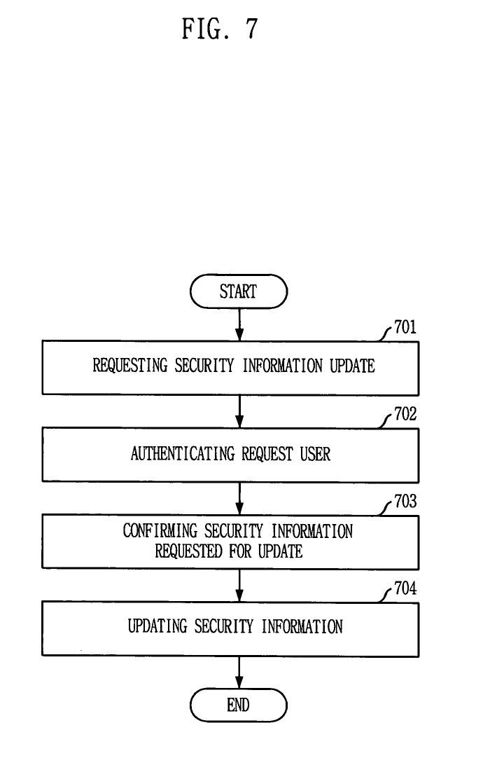

FIG. 7 is a flowchart illustrating a security information updating procedure according to the request from the extensible XKMS client in the integrated security information management system in accordance with a preferred embodiment of the present invention.

First, if the user requests updating of the self-owning security information through the extensible XKMS client 11 at step 701, the extensible XKMS server 131 authenticates the request user at step 702 and the update-requested security information is confirmed at step 703 and then updated at step 704.

As described above, the integrated security information management system in accordance with the present invention has an effect in that the compatibility problem of the security information can be solved by integrally managing a variety of security information and managing all security information according to the XML based international standard.

For example, if the user requests the integrated security information management system 13 for the bio information registration through the extensible XKMS client 11, the integrated security information management system 13 authenticates the user and then encrypts the bio information received from the user with the encryption algorithm and key selected by the user and then stores the encrypted bio information in the non-shared data storage 135.

If so, when a service provider performing the authentication using the bio information requests the bio information, the user encrypts his own bio information with the encoding algorithm and key and then signs together with a time stamp and the like to send the bio information to the service provider.

If so, the service provider requests the integrated security information management system 13 for the authentication of the encrypted bio information received from the user. After the integrated security information management system 13 informs the user of being requested for the authentication of the bio information through the extensible XKMS client 11, comparison is made with the encrypted bio information stored in the non-shared data storage 135 depending on user confirmation such that the compared result is notified to the service provider.

At this time, since the user can variously select the encryption algorithm and key for encrypting the bio information, the present invention has an effect of preventing a misuse of the bio information that may be generated by other persons.

The authentication using the above bio information can be used for a passport or a visa. That is, in the case of the passport, after the user extracts the bio information from the certification authority or a certification agency enterprise authorized by a nation, the bio information is encrypted using the algorithm and key publicly acknowledged by a counter nation and then registered into the non-shared data storage 135 of the integrated security information management system 13 managed by a public certification authority of the counter nation (for example, an immigration bureau).

If so, the counter nation can authenticate the bio information using the integrated security information management system 13 into which the bio information of the user is registered, when an entry and departure of the user is managed. In the case of the visa, the same method can be applied.

Meanwhile, the present invention can store the security information much used for the user authentication such as the password, the passphrase and the like in the limited shared data storage 134 such that a log-in process is omitted or that the security information is utilized in a Single Sign-On (SSO). The Single Sign-On (SSO) is a technology in which certification information of various business systems can be integrated into one single account such that a plurality of business systems can be simultaneously used with just one time log-in.

That is, if the user signs for the position information on the password or the passphrase according to the authentication request of the service provider, the service provider certifies the signature and then uses the position information received from the user to set the share for the password or the passphrase (the security information to be shared), and then stores URL, certificate information and the like of the service provider in the limited shared data storage 134 (security information share-agency setting function). At this time, the service provider can register a plurality of relation sites that the user does not register, and the user can be notified of the security information share-agency setting of the service provider through the extensible XKMS client 11. If so, thereafter, the user can omit a member subscription in or a log-in procedure to the site having the share set password or passphrase by the security information share-agency setting function. At this time, if Security Assertion Markup Language (SAML) is used as the security standard such that certification and acknowledgement information can be encrypted into the XML format for exchange, the Single Sign-On (SSO) can be managed more smoothly.

Further, it is so inconvenient to repetitively input personal information whenever a number of Internet service enterprises require the personal information at the time of the member subscription. However, if the personal information is stored in the XML format in the limited shared data storage 134 of the integrated security information management system 13 in accordance with the present invention, and the share set is made to the Internet service enterprise, the user needs not input the personal information to every Internet service enterprise. At this time, the personal information can be leveled depending on an importance degree and the share can be set depending on each of levels.

If the user wants to withdraw from his subscribing Internet service enterprise, a withdrawal request acknowledgement signature is received from the Internet service enterprise to be stored in the non-shared data storage 135 such that a personal information illegal usage and leakage and the like can be coped occurring after withdrawal. An agreement of the Internet service enterprise can be also applied in the same manner. This can be embodied using P3P (Platform for Privacy Preference) defined in the W3C (World Wide Web Consortium).

If being embodied above, the present invention has an advantage in that the Internet service enterprise needs not separately make an effort for a personal information protection and can easily obtain the user information. On the other hand, the present invention has an advantage in that the person has a convenience since repetitive input of the personal information can be omitted.

Further, the present invention has an effect in that as the private key can be stored in the limited shared data storage and can be shared by several share set users, the key distribution problem can be solved.

As described above, the method in accordance with the present invention can be embodied into a program to be stored in a computer-readable medium (CD-ROM, RAM, ROM, floppy disk, hark disk, optic-magnetic disk, and the like). Since this procedure can be easily executed by those skilled in the art, its detailed description will be omitted.

As described above, the present invention has an effect in that the compatibility problem of the security information can be solved by integrally managing the various security information and managing all security information according to the XML based international standard.

Additionally, the present invention has an effect in that the key distribution problem can be solved by storing the private key in the limited shared data storage and allowing several share set users to share the stored private key.

Further, in accordance with the present invention, since the security information is excellent in mobility and the log-in process can be omitted, a user's convenience is improved. Further, since a keyboard input is minimized, a utilization of miniaturized wireless Internet instrument is improved.

While the present invention has been described with respect to the particular embodiments, it will be apparent to those skilled in the art that various changes and modifications may be made without departing from the scope of the invention as defined in the following claims.

What is claimed is:

1. An integrated security information management system, comprising:
an Extensible Markup Language (XML) key managing means for performing an interface with an external security information management client based on an XML, authenticating a user, analyzing a request from the integrated security information management client, and requesting a processing to an access control means, an authenticating means or an external public key infrastructure certification server depending on a request kind;
the access control means for providing a user authenticating function, an access authority policy generating function for limited shared data storing means, an access authority confirming function depending on the access authority policy, a shared security information providing function for an access-allowed user, a security information position information providing function, a shared security information registering/deleting/updating function, a shared security information share setting/releasing function, and an XML digital signature/verification/encryption/decryption/communication security function depending on a shared security information processing request from the XML key managing means;
the authenticating means for providing the user authenticating function, a person-in-question authenticating function, a non-shared security information providing function for the access-allowed user (the person-in-question), a security information position providing function, a non-shared security information registering/modifying/deleting function, and the XML digital signature/verification/encryption/decryption/communication security function depending on a non-shared security information processing request from the XML key managing means;
the limited shared data storing means for storing and managing security information shared by an object limited depending on a control of the access control means; and
non-shared data storing means for storing and managing security information that should not be shared depending on control of the authenticating means.

2. The integrated security information management system as recited in claim 1, wherein in the access authority confirming function depending on an access authority policy of the access control means, if the access control means receives an access request to the limited shared data storing means from the XML key managing means, after a user authentication is performed, the access authority policy corresponding to the requested security information is read to confirm whether or not a user has authority.

3. The integrated security information management system as recited in claim 2, wherein when the user registers the security information through the integrated security information management client, the access authority policy is generated and is continuously and dynamically updated depending on updating/deleting and share setting/releasing of the security information later registered.

4. The integrated security information management system as recited in any one of claims 1 to 3, wherein the access control means and the authenticating means uses a signature received from a security information owner according to the request of the integrated security information management client to further perform a security information share-agency setting function for allowing other users to set/release a share and a function of informing the security information owner of a security information share-agency setting request.

5. The integrated security information management system as recited in claim 4, wherein the access control means and the authenticating means uses a signature and a certificate issued from other users according to the request of the integrated security information management client to further perform a shared security information retrieving function for retrieving the security information shared by a self, a shared security information retrieval confirming function for informing the security information owner of execution of the shared security information retrieving function depending on the execution, and a shared security information usage log confirming function for confirming a log for a shared security information usage.

6. An integrated security information management method, comprising the steps of:
classifying security information depending on its kind according to a security information registering/updating/deleting request from an integrated security information management client to register/update/delete the classified security information from a limited shared data storage or a non-shared data storage at an integrated security information management system;
setting/releasing a share for the security information registered into the limited shared data storage according to a security information share setting/releasing request from the integrated security information management client, and generating/updating a security access authority policy at the integrated security information management system;
confirming a request user's authority depending on a security access authority policy according to a shared security information providing request from the integrated security information management client, and then providing corresponding security information for the integrated security information management client at the integrated security information management system;
authenticating that a request user is a non-shared security information owner according to a non-shared security information providing request from the integrated security information management client, and then providing corresponding security information for the integrated security information management client at the integrated security information management system; and
generating/verifying a digital signature according to a digital signature generating/verifying request using an XML from the integrated security information management client at the integrated security information management system.

7. The integrated security information management method as recited in claim 6, further comprising the step of:
informing a security information owner of a security information share-agency setting request according to an other owners' security information share-agency setting request from the integrated security information management client to receive acknowledgement, and then allowing other users to use a signature received from the security information owner to set/release the share for corresponding security information at the integrated security information management system.

8. The integrated security information management method as recited in claim 6 or 7, further comprising the step of:
informing the security information owner of a security information verifying request according to an other owners' security information verifying request from the integrated security information management client to receive acknowledgement, and then providing a verified result of other owners' security information for the integrated security information client at the integrated security information system.

9. The integrated security information management method as recited in claim 8, wherein the security information registering/updating/deleting step comprises the steps of:
a user's requesting an extensible XKMS server of the integrated security information management system for security information registration/update/deletion through the integrated security information management client;
authenticating the request user and confirming a security information kind at the extensible XKMS server;
as the confirmation result, if the security information kind is sharable, sending the request to an access control server to register/update/delete the security information from a limited shared data storage; and
as the confirmation result, if the security information kind is non-sharable, sending the request to an authentication server to register/update/delete the security information from a non-shared data storage.

10. The integrated security information management method as recited in claim 8, wherein the security information share setting/releasing step comprises the steps of:
a user's requesting the extensible XKMS server of the integrated security information management system for security information share set/release through the integrated security information management client;
authenticating the request user at the extensible XKMS server, and then sending a security information share setting/releasing request to the access control server, and loading an access authority policy for corresponding security information at the access control server, and then confirming whether or not the access authority policy is set to allow the request user to share; and
as the confirmation result, in case the access authority policy is set to allow the request user to share, reading the corresponding security information from the limited shared data storage to send the read security information to the request user through the integrated security information management client.
